(19) United States
(12) Patent Application Publication
(10) Pub. No.: US 2026/0087866 A1
(43) Pub. Date: Mar. 26, 2026

(54) SYSTEMS AND METHODS FOR CONTROLLING A MOVABLE BARRIER OPERATOR AS A FUNCTION OF A LOCATION OF A VEHICLE

(71) Applicant: THE CHAMBERLAIN GROUP LLC, OAK BROOK, IL (US)

(72) Inventors: Maged Riad, Roselle, IL (US); Oddy Khamharn, Lombard, IL (US)

(21) Appl. No.: 18/894,498

(22) Filed: Sep. 24, 2024

(51) Int. Cl. G07C 9/00; G01S 13/02; G01S 13/46

(52) U.S. Cl. CPC G07C 9/00896; G01S 13/0209; G01S 13/46; G07C 9/00309; G01S 2013/468; G07C 2009/00793; G07C 2009/00928

(57) ABSTRACT

Systems and methods for controlling a movable barrier operator. The system is configured to perform operations that include identifying a plurality of zones relative to a structure. The system may also be configured to perform operations that include obtaining information associated with a location of a vehicle relative to the plurality of zones as a function of a spatial relationship between a first wireless communication accessory and a second wireless communication accessory. The system is additionally configured to perform operations that include determining a control instruction to control a state of the movable barrier operator in response to the location of the vehicle relative to at least one zone of the plurality of zones. The system is configured to perform operations that include causing communication of the control instruction to the movable barrier operator to control the state of the movable barrier operator.

### FIELD

The present disclosure relates generally to systems and methods for controlling a movable barrier operator. More particularly, the present disclosure relates to tracking the location of a vehicle relative to a plurality of zones and controlling a movable barrier operator based on the location of the vehicle.

### BACKGROUND

Automatedly operating a movable barrier operator has long been a time consuming and challenging process. Experts in the field have long had trouble integrating real-time vehicle position data with movable barrier control systems. This is primarily due to challenges presented in detecting vehicle position and interpreting vehicle position data to generate appropriate control instructions for the movable barrier operator.

Accordingly, improved systems for controlling a movable barrier operator are desired in the art. In particular, there is a need for systems for controlling a movable barrier operator that can provide an improved parking experience.

### BRIEF DESCRIPTION

Aspects and advantages of the invention in accordance with the present disclosure will be set forth in part in the following description, or may be obvious from the description, or may be learned through practice of the technology.

In accordance with one embodiment, a system for controlling a movable barrier operator is provided. The system includes one or more processors. The system also includes one or more non-transitory computer-readable media that collectively store instructions that, when executed by the one or more processors, cause the computing system to perform operations. The system is configured to perform operations that include identifying a plurality of zones relative to a structure. The system may also be configured to perform operations that include obtaining information associated with a location of a vehicle relative to the plurality of zones as a function of a spatial relationship between the first wireless communication accessory and the second wireless communication accessory. The system is additionally configured to perform operations that include determining a control instruction to control a state of the movable barrier operator in response to the location of the vehicle relative to at least one zone of the plurality of zones. The system is configured to perform operations that include causing communication of the control instruction to the movable barrier operator to control the state of the movable barrier operator.

In accordance with another embodiment, a method for controlling a movable barrier operator is provided. The method includes identifying, by a computing system comprising one or more processors, a plurality of zones relative to a structure, wherein the structure comprises a movable barrier operator communicatively connected to a first wireless communication accessory configured to detect a second wireless communication accessory. The method also includes obtaining, by the computing system, information associated with a location of a vehicle relative to the plurality of zones as a function of a spatial relationship between the first wireless communication accessory and the second wireless communication accessory, wherein the second wireless communication accessory is mounted to the vehicle. The method additionally includes determining, by the computing system, a control instruction to control a state of the movable barrier operator in response to the location of the vehicle relative to at least one zone of the plurality of zones. The method includes causing, by the computing system, communication of the control instruction to the movable barrier operator to control the state of the movable barrier operator.

In accordance with a third embodiment, a system for controlling a movable barrier operator is provided. The system includes one or more processors. The system also includes one or more non-transitory computer-readable media that collectively store instructions that, when executed by the one or more processors, cause the computing system to perform operations. The system is configured to perform operations that include identifying a plurality of zones relative to a garage, wherein the garage comprises a movable barrier operator communicatively connected an ultra-wide band (UWB) system, wherein the UWB system comprises an anchor and a tag. The system is also configured to perform operations that include obtaining information associated with a location of a vehicle relative to the plurality of zones as a function of a spatial relationship between the anchor and the tag, wherein the anchor is mounted to the vehicle. The system is configured to perform operations that include determining, by the computing system, a control instruction to control a state of the movable barrier operator in response to the location of the vehicle relative to at least one zone of the plurality of zones. The system is additionally configured to perform operations that include causing communication of the control instruction to the movable barrier operator to control the movable barrier operator.

These and other features, aspects and advantages of the present invention will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present invention, including the best mode of making and using the present systems and methods, directed to one of ordinary skill in the art, is set forth in the specification, which makes reference to the appended figures, in which:

FIG. 1 depicts a block diagram of an exemplary system of controlling a movable barrier operator in accordance with embodiments of the present disclosure;

FIG. 2 depicts a top view of a plurality of zones in accordance with embodiments of the present disclosure;

FIG. 3 depicts a side view of a plurality of zones in accordance with embodiments of the present disclosure;

FIG. 4 depicts a top view of an orientation of a vehicle within a least one zone of the plurality of zones in accordance with embodiments of the present disclosure;

FIG. 5 depicts a flow chart diagram of an exemplary method of generating reposition data using a parking model according to example embodiments of the present disclosure;

FIG. 6A-B depict exemplary embodiments of wireless communication accessories in accordance with embodiments of the present disclosure; and

FIG. 7 depicts a flow chart diagram of an exemplary method of controlling a movable barrier operator according to example embodiments of the present disclosure.

### DETAILED DESCRIPTION

Reference now will be made in detail to embodiments of the present invention, one or more examples of which are illustrated in the drawings. The word “exemplary” is used herein to mean “serving as an example, instance, or illustration.” Any implementation described herein as “exemplary” is not necessarily to be construed as preferred or advantageous over other implementations. Moreover, each example is provided by way of explanation, rather than limitation of, the technology. In fact, it will be apparent to those skilled in the art that modifications and variations can be made in the present technology without departing from the scope or spirit of the claimed technology. For instance, features illustrated or described as part of one embodiment can be used with another embodiment to yield a still further embodiment. Thus, it is intended that the present disclosure covers such modifications and variations as come within the scope of the appended claims and their equivalents. The detailed description uses numerical and letter designations to refer to features in the drawings. Like or similar designations in the drawings and description have been used to refer to like or similar parts of the invention.

As used herein, the terms “first,” “second,” and “third” may be used interchangeably to distinguish one component from another and are not intended to signify location or importance of the individual components. The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present), and B is false (or not present), A is false (or not present), and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise, or counterclockwise.

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

Generally, the present disclosure is directed to systems and methods for controlling a movable barrier operator. In particular, the system and methods disclosed herein may leverage various wireless communications technologies to identify a location of a vehicle relative to a plurality of zones. Identifying the location of the vehicle may be done by identifying a spatial relationship between two or more wireless communication accessories. Based on the spatial relationship, the systems and methods disclosed herein may control a state of the movable barrier operator as a function of the location and/or movements of the vehicle within a geographic zone that is defined by the system.

For example, the systems and methods disclosed herein may include a first wireless communication accessory configured to track the second wireless communication accessories. Tracking a location of the second wireless communication accessories relative to the first wireless communication accessory may include identifying a spatial relationship between each of the first and second wireless communication accessories. The spatial relationship may refer to the way in which objects (i.e., wireless communication accessories) are positioned in relation to each other within a given space. Spatial relationships may be defined in terms of relative position, distance, orientation, dimensions of the objects (e.g., vehicle(s)), and the like.

The systems and methods disclosed herein may identify a spatial relationship between the wireless communication accessories using an ultra-wide band (UWB) system. UWB systems may employ a substantial portion of a radio frequency spectrum with very low power levels over a short range. UWB systems may spread their signal over a wide frequency range, typically spanning several gigahertz (GHz) or more. In an embodiment, UWB systems may operate over a frequency range spanning from 3.1 GHz to 10.6 GHz. The UWB system may include a first wireless communication accessory and a plurality of second wireless communication accessories. As used in the current disclosure, a wireless communication accessory may be a transceiver (tag/anchor). In a non-limiting embodiment of the current system, the first wireless communication accessory may be the receiver, and the second wireless communication accessories may include transmitters. The first wireless communication accessory may be mounted within a structure (such as a garage associated with a house or a public parking space), while the second wireless communication accessories may be mounted to a vehicle (such as within an interior space of the vehicle, within a framework of the vehicle, or the like). In some instances, the second wireless communication accessories may be mounted to the vehicle during a manufacturing process of the vehicle or by a dealer prior to sale of the vehicle.

The systems and methods disclosed herein may identify a spatial relationship between the first wireless communication accessory and the second wireless communication accessories using time-of-flight (ToF) of radio signals transmitted between the first and second wireless communication accessories. ToF may be useful in identifying the distance between one or more wireless communication accessories. In an embodiment, the first wireless communication accessory and the second wireless communication accessories may communicate through short-duration, high-bandwidth pulses. For example, in response to the second wireless communication accessories emitting radio signals, the first wireless communication accessory receives the emitted radio signal and measures the duration of time it took for the radio signal to travel from the second wireless communication accessories to the first wireless communication accessory. This measurement of time may be useful because the speed of radio waves is a constant, known value (the speed of light). By multiplying the time of flight by the constant, known speed of the radio wave, the distance between the first wireless communication accessory and the second wireless communication accessories can be accurately calculated. This distance measurement may be used to determine the spatial relationship between the first wireless communication accessory's position and the position of the second wireless communication accessories.

In some cases, pairing of the first and second wireless communication accessories may trigger the second wireless communication accessories to emit an initial radio signal to the first wireless communication accessory. The first and second wireless communication accessories may be paired as a function the location of the vehicle relative to the plurality of zones. Additionally, the first and second wireless communication accessories may be paired based on changes to the operational status (e.g., engine on/off) of the vehicle. Once the first and second wireless communication accessories are paired the second wireless communication accessories may emit an initial radio signal to the first wireless communication accessory, thereby providing an initial location of the vehicle to the system.

In an embodiment, identifying the spatial relationship between two or more wireless communication accessories may include identifying the orientation of the second wireless communication accessories relative to the first wireless communication accessory. Orientation may refer to the angular alignment, angle of arrival (AoA) or angle of departure (AoD) of at least one wireless communication accessory in relation to another wireless communication accessory or coordinate system. Orientation may describe the direction or angle relative to a fixed point of reference (e.g., the first wireless communication accessory).

Orientation of a vehicle may refer to angle of approach of the vehicle (containing the second wireless communication accessories) as it relates to the first wireless communication accessory. Orientation may include information about the direction in which the vehicle/wireless accessory is facing as it relates to a designated point (i.e., a location of the first wireless accessory). The term orientation may be used to describe the angle of approach or angle of attack of a vehicle. This angle may measure the degree at which the vehicle's trajectory intersects with the designated point or another target area. For instance, if a vehicle is approaching a parking space, the orientation may describe how the vehicle's front end aligns with the entrance of the parking space or how a length dimension of the vehicle aligns with respect to the parking space.

The orientation of a vehicle may be calculated with the assistance of an inertial movement unit (IMU), such as a gyroscope, that is coupled to (e.g., embedded within), the second wireless communication device. The UWB system may record the distance between the first wireless communication accessory and the second wireless communication accessories as a function of the ToF of the transmitted radio signals. as well as calculating the orientation of the vehicle using the AoA and AoD of the signals. This distance measurement may be further processed in view of gyroscopic data generated by the IMU, such as the gyroscope, to provide more granular orientation information. Gyroscopes generally include a sensor that detects and measures rotational motion or angular velocity around one or more of the device's axes. The gyroscope may be used to detect changes in the orientation of the device and/or vehicle by monitoring the rate at which the device is rotating. Gyroscopic data may include information related to the measurement of the rotational movements of the wireless communication accessory. Using the distance measurement from the ToF and the gyroscopic data from the gyroscope, a system processor can calculate the spatial relationship between the first wireless communication accessory and the second wireless communication accessories. This spatial relationship may be used to determine an initial location of the vehicle. This initial location may include both the orientation and the position of the vehicle. From this initial location, the systems and methods disclosed herein may be used to guide the vehicle into a desired parking space within a structure. As the second wireless communication accessories move (i.e., as a result of vehicle movement relative to the first wireless communication accessory), the gyroscopic data may be used to continuously update the angle of approach of the vehicle.

In an embodiment, the orientation of the vehicle may be determined by measuring the difference between the AoA and the AoD of the UWB signals. Within the context of the current disclosure, the angle of attack refers to the direction from which the UWB signals are received by the second wireless communication accessories. Alternatively, angle of departure refers to the direction from which the UWB signals are transmitted by the first wireless communication accessory. The system may determine the orientation of the vehicle by analyzing the differences in these angles as the vehicle moves. The system may calculate the orientation of the vehicle with respect to its environment. This orientation data, combined with the spatial relationship between the first and second wireless communication accessories, may allow the system to triangulate the vehicle's orientation.

The systems and methods disclosed herein may identify a plurality of zones relative to the structure (e.g., garage). The plurality of zones may represent multiple geographic areas within and/or adjacent to the structure. In an embodiment, the structure may include any geographic area that has an access point with a movable barrier. The structure may include areas that are covered or uncovered. This may include both commercial and residential structures. Specifically, structures may include vehicle storage areas such as parking lots, parking garages, residential garages, carports, covered parking, parking spaces, and the like. The structure may additionally include access points for a geographic area such as roads, driveways, paths, and the like.

One or more movable barrier operators may be located within or adjacent to the structure. The movable barrier operator may be configured to actuate a movable barrier between two or more positions to selectively allow people, goods, and/or vehicles access to a secured area defined by the structure. In a non-limiting example, the movable barrier operator may include a garage door opener and/or an actuator used to move a gate or barrier arm. In an embodiment, the movable barrier may include one or more garage doors, automated locks, alarm systems, lift gates, sliding gates, automatic doors at a secured building, and/or other controllable devices.

In an embodiment, each zone of the plurality of zones may be used to denote a specific area on a path to a parking space within the structure. Each zone of the plurality of zones may represent a portion of the path a vehicle must take to access a desired parking space within the structure. A zone may refer to a geographic area that is wholly or partially within the structure. Alternatively, a zone may be at least partially outside of the structure or even fully outside of the structure. In an embodiment, a first zone may represent a safe parking area for a vehicle within the structure. The safe parking area may be an area within the structure that allows a movable barrier to be opened/closed without damaging the vehicle. In an embodiment, the first zone (safe parking area) may be adjusted as the environment of the structure changes, e.g., as a function of identifying an obstruction or obstacle within the safe parking area. In an additional embodiment, a second zone may represent a geographic area that is partially within the structure and partially outside of the structure. The second zone may be defined as an area adjacent to the movable barrier. When a vehicle, wholly or partially, is present within the second zone the system may prohibit the movable barrier operator from actuating the movable barrier. More particularly, the system may prohibit the movable barrier operator from closing the movable barrier when the vehicle is detected in the second zone. A third zone may be located completely outside of the structure. Similar to the first zone, the system can affect a state of the movable barrier when a vehicle is in third zone. More particularly, the system allows the movable barrier to be opened/closed without colliding with the vehicle when the vehicle is in the third zone. A fourth zone may be located aft of the third zone. The term after is used herein to describe a location whereby the third zone is located between the fourth zone and the movable barrier. The fourth zone may define a maximum distance over which the first wireless accessory detects and can pair with the second wireless accessory.

In some implementations, the system can utilize a camera in communication with an image processing model to identify each zone of the plurality of zones. The image processing model may include a machine learning model. In some implementations, one or more machine learning models can include models such as neural networks (e.g., deep neural networks) or other types of machine-learned models, including non-linear models and/or linear models. Neural networks can include convolutional neural networks, feed-forward neural networks, recurrent neural networks (e.g., long short-term memory recurrent neural networks), or other forms of neural networks. Additionally, the machine learning model may include one or more transformer models. The machine learning model may include a convolutional neural network, a detection model, a natural language processing model, a segmentation model, a classification model, an augmentation model, a generative model, a discriminative model, and/or one or more other model types. The machine learning model can receive images captured by the camera and determine locations of at least some of the plurality zones. Alternatively, a user can manually identify each zone of the plurality of zones. For example, the user can rely on images captured by the camera to manually draw the zones. Alternatively, or in addition, the user can use a map of the environment to draw zone(s) or select areas within the environment for zone generation. Yet other types of zone identification are contemplated herein.

With reference now to the Figures, example embodiments of the present disclosure will be discussed in further detail.

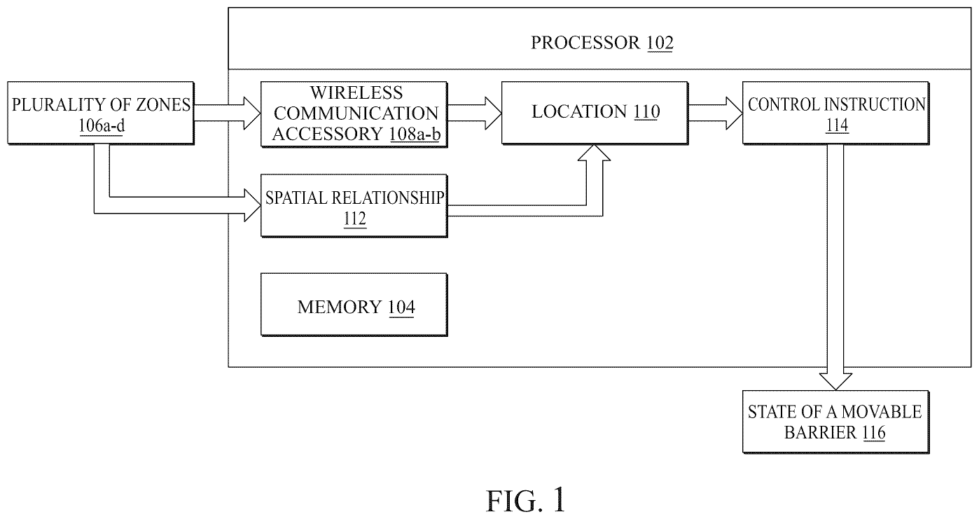

FIG. 1 depicts a block diagram of an exemplary system 100 for controlling a movable barrier operator. System 100 includes one or more processors 102 that can be utilized to perform one or more operations. The one or more processors 102 can include any suitable processing device (e.g., a processor core, a microprocessor, an ASIC, a FPGA, a controller, a microcontroller, etc.) and can be one processor or a plurality of processors that are operatively connected. The one or more processors 102 can perform operations in series and/or in parallel. The one or more processors 102 may be dedicated to a particular computing device and/or may be utilized by a plurality of devices to perform processing tasks. In an embodiment, processor 102 could be situated within each of these various computing devices, such as the vehicle control system, infotainment system, navigation system, electronic control units (ECUs), wireless communication accessories, remote computing devices, and the like. One or more of these computing devices may be employed to handle specific processing tasks and operations.

Processor 102 may be designed and/or configured to perform any method, method step, or sequence of method steps in any embodiment described in this disclosure, in any order and with any degree of repetition. For instance, processor 102 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. This may be used to train, refine, or otherwise improve any algorithm, model, machine learning model, and the like mentioned herein.

Processor 102 may include a single computing device operating independently, or may include two or more computing devices operating in concert, in parallel, sequentially or the like; two or more computing devices may be included together in a single computing device or in two or more computing devices. Processor 102 may include but is not limited to, for example, a computing device or cluster of computing devices in a first location and a second computing device or cluster of computing devices in a second location. Processor 102 may include one or more computing devices dedicated to data storage, security, distribution of traffic for load balancing, and the like. Processor 102 may distribute one or more operations as described below across a plurality of computing devices, which may operate in parallel, in series, redundantly, or in any other manner used for distribution of tasks or memory between computing devices.

System 100 may include memory 104 that can store data and/or instructions. Memory 104 can include one or more non-transitory computer-readable storage mediums, such as RAM, ROM, EEPROM, EPROM, flash memory devices, magnetic disks, etc., and combinations thereof. The data can include user data, application data, operating system data, etc. The data can include text data, image data, audio data, statistical data, latent encoding data, etc. The instructions can include instructions that when executed by one or more of the processors 102 may cause system 100 to perform operations as described herein.

Memory 104 may store data and/or instructions associated with one or more applications. The one or more applications can include native, factory-set applications and/or downloaded applications. The applications may include one or more messaging applications, one or more image capture applications, one or more social media applications, one or more productivity applications, one or more map applications, one or more device management applications, one or more browser applications, and the like. In some implementations, the applications can include one or more applications communicatively connected to one or more server computing systems for providing access to a platform. For example, the applications can include an application for controlling a movable barrier operator as a function of the location of a vehicle.

### Defining and Identifying the Plurality of Zones

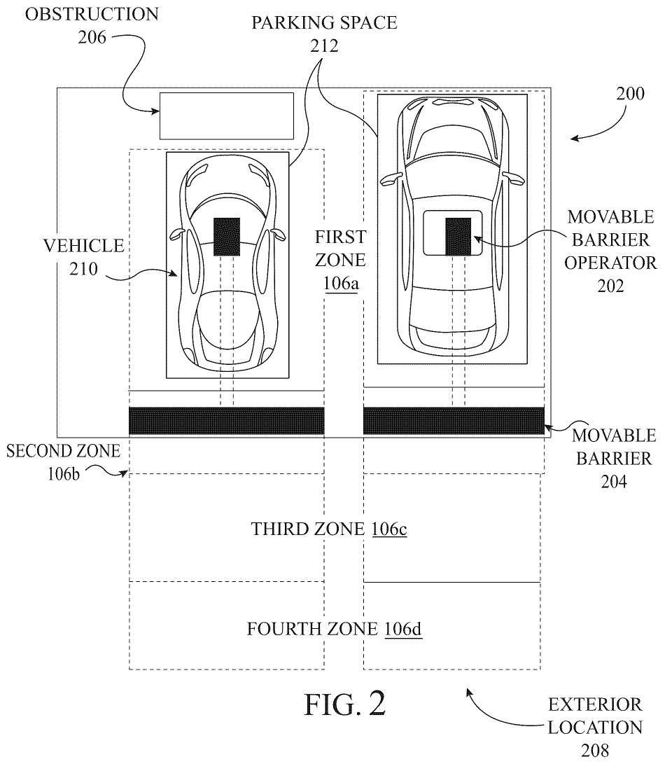

Referring now to FIG. 2, a depiction of a top view of a plurality of zones 106a-d in accordance with embodiments of the present disclosure. The plurality of zones includes the first zone 106a, the second zone 106b, the third zone 106c, and the fourth zone 106d. The plurality of zones 106a-d may be used to designate specific areas along a path from an exterior location 208 to a parking space within a structure, with each zone 106a-d serving a distinct function based on its location and purpose. Each zone 106a-d may represent a segment of the path that a vehicle 210 may navigate to access its intended parking space 212. FIG. 2 depicts a structure in the form of a garage having two movable barriers 204, i.e., two separate garage doors, each associated with a different vehicle bay (i.e., parking space 212). Each of the garage doors is separately controllable by a movable barrier operator 202. The following description relates to either of the vehicle bays.

In an embodiment, the first zone 106a is an area in which the vehicle will be parked. The location of the first zone 106a may be designed to ensure that the vehicle 210 can be parked without impeding the functionality of the movable barrier 204, such as a garage door or gate. The first zone 106a may include a parking space 212 where the vehicle 210 must be positioned to allow the movable barrier 204 to close without impacting the vehicle 210. The dimensions of the first zone 106a may be calibrated to accommodate the vehicle's size while providing sufficient clearance around the vehicle 210. That is, the first zone 106a may be larger than the vehicle 210. The boundary of the first zone 106a may be adjusted based on the identification of any obstructions 206 within the area, ensuring that the space remains clear for safe operation of the movable barrier operator 202. For example, the first bay is shown with an obstruction 206 at a distal end of the garage (i.e., in front of the vehicle). The obstruction 206 might include garage shelving, an alcove from an adjacent structure (e.g., the outer wall of the house), or the like. The first zone 106a is depicted smaller for the first bay as compared to the second bay in view of the detected obstruction 206.

In an embodiment, the second zone 106b is disposed at, e.g., surrounds, the movable barrier 204. The second zone 106b may be defined as an area that partially overlaps both the interior and exterior of the structure, strategically situated around the movable barrier 204 such as a gate or garage door. Alternatively, the second zone 106b may be described as the area that is aft of the first zone 106a and fore of the third zone 106c. When the vehicle 210 is detected within the second zone 106b, the system 100 enforces a restriction on movement of the movable barrier 204 by the movable barrier operator 202 to prevent collision of the movable barrier 204 with the vehicle 210. Alternatively, controlling the state of the movable barrier operator 202 may include engaging the movable barrier operator 202 as a function of the vehicle 210 exiting the second zone 106b.

In an embodiment, the third zone 106c is located outside of the movable barrier 204. More particularly, the third zone 106c may be disposed entirely outside of the structure. The third zone 106c may define a closest boundary to the second zone 106b beyond an outer boundary of the structure, thereby providing room for the movable barrier 204 to close without colliding with the vehicle 210. In an embodiment where the vehicle 210 exits the structure and enters the third zone 106c, the movable barrier operator 202 may be activated to close the movable barrier 204. The system 100 may ensure that operation of the movable barrier operator 202 is contingent upon the vehicle's full presence within the third zone 106c. That is, the movable barrier operator 202 may be prevented from closing the movable barrier 204 while any part of the vehicle 210 remains within the second zone 106b.

In an embodiment, the fourth zone 106d begins where the first wireless communication device and the second wireless communication device establish a pairing connection and extends to the border of the third zone 106c. The fourth zone 106d may begin at the point where the wireless communication accessories 108a-f (FIG. 1) come into range of each other. This typically occurs when a distance between the wireless communication accessories 108a-f is within no greater than 50 meters, such as no greater than 40 meters, such as no greater than 30 meters for UWB systems or up to 100 meters for Bluetooth systems. The fourth zone 106d serves as a critical pairing area, ensuring that the wireless devices can synchronize effectively prior to the vehicle 210 reaching the third zone 106c, and more particularly prior to the vehicle 210 reaching the movable barrier 204.

With continued reference to FIG. 1, processor 102 may perform operations comprising identifying a plurality of zones 106a-d relative to a structure. To aid in the identification of the plurality of zones 106a-d, processor 102 may receive data associated with the structure. This data may include images of a path to be taken by, or already taken by, a vehicle to a desired parking space within the structure. These images may include images from various vantage points of the interior/exterior of the structure or from a single, fixed vantage point. In an embodiment, these images may be taken from each boundary of the interior of the structure. For example, a first image can be captured from a first side of the interior, a second image can be captured from a second side of the interior, etc. The images may also include images of areas surrounding the movable barrier, such as areas outside of the structure.

Processor 102 may process this image data to identify various landmarks and/or obstacles within these images. Landmarks may be various features or objects that serve as reference points in and around the structure. These landmarks may include things like stairs, doors, inaccessible areas, shelves, boundaries of the secured area (i.e., walls, fences, parking lines, etc.). Landmarks may additionally include details related to the location of each movable barrier within the structure. This data may be gathered through a camera or another capture device. The camera(s) may be incorporated into a user device, a vehicle, a security device (such as an alarm system), and/or located around the entry point to the structure. The camera(s) may capture low-resolution images, high-resolution images, and/or video feeds of the vehicle path into the secured area, including roadways, entry gates, barriers, garages, and any potential obstacles. The image data may be processed using computer vision algorithms to detect and interpret the landmarks and obstacles. Additionally, the image data may be processed using image processing model or image processing techniques that are disclosed herein.

Processor 102 may employ one or more algorithms or machine-learning models to identify both landmarks and boundaries between zones within the image data. Processor 102 may first recognize landmarks such as the layout of the structure. This may include the identification of physical boundaries within the structure such as walls, fences, changes in terrain, and the like. Processor 102 may conduct a spatial analysis to group and categorize sections of the area into a plurality of zones 106a-d, including a first zone 106a, a second zone 106b, a third zone 106c, and a fourth zone 106d. In an embodiment, the plurality of zones 106a-d can include less than four zones or greater than four zones. Grouping and categorization may be based on proximity to landmarks, containment within boundaries, or other spatial relationships identified through the analysis. In a non-limiting example, the first zone 106a may be categorized by its containment within the boundaries of the structure. In a second non-limiting example, the second zone 106b may be categorized by its location relative to the movable barrier. The result of the grouping and categorization process may include a map or visual representations of each zone of the plurality of zones 106a-d. This may include specific information such as the distance from a mounted position of a first wireless communication accessory 108a to the various boundaries of each zone of the plurality of zones 106a-d. For example, this may include a distance measurement from location of the first wireless communication accessory 108a to the boundary between the first zone 106a and the second zone 106b.

In an embodiment, a plurality of zones 106a-d may be identified by tracing on an image within the image data. The image data associated with the structure may be examined to identify distinctive landmarks, obstacles, and features. These features may serve as an initial reference point for understanding the spatial layout of the area. Processor 102 may display the images to a user via a user device. Processor 102 may provide instructions to the user to outline one or more zones of the plurality of zones 106a-d on the provided image. This may include prompting the user to trace or digitally outline specific landmarks that may be used to identify the boundaries between each zone of the plurality of zones 106a-d. Alternatively, the user can move a boundary marker or box to correspond to a desired zone placement. In some instances, the processor may smooth or adjust the boundary marker or box. Tracing may define borders that separate one zone from another zone, such as the first zone 106a from the second zone 106b, based on the observed features and characteristics at each of the zones. Each traced boundary may encapsulate at least one zone of the plurality of zones within the image, facilitating clear demarcation and categorization. Setting the boundaries between the plurality of zones 106a-d can be completed manually and/or through one or more automated algorithms.

It may be desirable for the user to manually capture image data of the structure, the nearby environment, the parking space within the structure, and the like. In some instances, the processor 102 may determine whether additional image data is desirable. For example, the processor 102 can compare already-obtained image data (e.g., image data obtained from a camera associated with the movable barrier operator or a separate image capture device) against a threshold value to determine whether sufficient image data exists. Where sufficient image data exists, the processor 102 can then perform the steps and methods described herein. Conversely, where the comparison of already-obtained image data to the threshold value is determined to be unsatisfactory, the processor 102 can cause the user to capture additional images. Processor 102 may transmit detailed instructions to the user through a user device (such as a smart phone, tablet, etc.) for generating image data of the structure. For instance, the instructions may include the location or GPS coordinates where images of the structure should be captured. This may include instructions to generate image data looking into the structure while standing near the movable barrier. Instructions might also include guidance on optimal angles for capturing key features of, or associated with, the structure. Recommendations on ideal lighting conditions, focus settings, depth of field parameters, positioning, angle, lighting, and the like can also be included in the detailed instructions.

Boundary data associated with the plurality of zones 106a-d may alternatively, or additionally, be determined by tracking the position of the second wireless communication accessories 108b-f using the first wireless communication accessory 108a. In this embodiment, the second wireless communication accessories 108b-f may include a user device or a transmitter/receiver that can be removably attached to the vehicle. For example, the first wireless communication accessory 108a may be mounted at a fixed, known location at the structure, such as at least partially within the structure. To set the boundaries of the zones (or at least provide data which assists in setting the boundaries), a user may sequentially move between various points within the structure while holding the second wireless communication accessories 108b-f. The various points can correspond with corner or boundary points of the structure and/or desired boundaries of one or more of the plurality of zones 106a-d. In some instances, the user can notify arrival at the corner or boundary point by actuating a user interface of the second wireless communication accessories 108b-f. In response to arriving at each point, the first wireless communication accessory may measure the distance and/or orientation between the first and second wireless communication accessories 108a, 108b-f using ToF, AoA, and/or AoD e.g., as described above. This distance and/or orientation data, combined with the known position of the first wireless communication accessory 108a, may allow processor 102 to generate coordinates of each point. These coordinates may be used to define the boundaries of each zone.

In an embodiment, a user may use the first wireless communication accessory 108a to generate boundary data based on the location of the second wireless communication accessories 108b-f and a known location of the vehicle. In an embodiment, the second wireless communication accessories 108b-f may be mounted at a fixed location in or around the vehicle. Additionally, the vehicle may be parked within a desired parking space 212 within the at least one zone of the plurality of zones 106a-d, Based on the location of the vehicle and the second wireless communication accessories 108b-f, a user may use the first wireless communication accessory 108a to map out one or more zones of the plurality of zones 106a-d. This may be done in a manner similar to the process for generating boundary data described herein above. To set the boundaries of the zones, a user may sequentially move between various points around a fixed point while holding the first wireless communication accessory 108a. In this case, the fixed point may be the parked vehicle and/or the parking space 212. Similar to the process described herein above, the various points can correspond with corner or boundary points of the structure and/or desired boundaries of one or more zones of the plurality of zones 106a-d. When arriving at each point, the first wireless communication accessory 108a can measure the distance to the second wireless communication accessories 108b-f using Time of Flight (ToF), as previously described. By combining this distance and orientation data with the known position of the second wireless communication accessories 108b-f, processor 102 can calculate the coordinates for each point. These coordinates are then used to outline the boundaries of each zone. Once the boundaries of each zone are outlined, the first wireless communication accessory 108a can be securely mounted to a fixed location within the structure or garage.

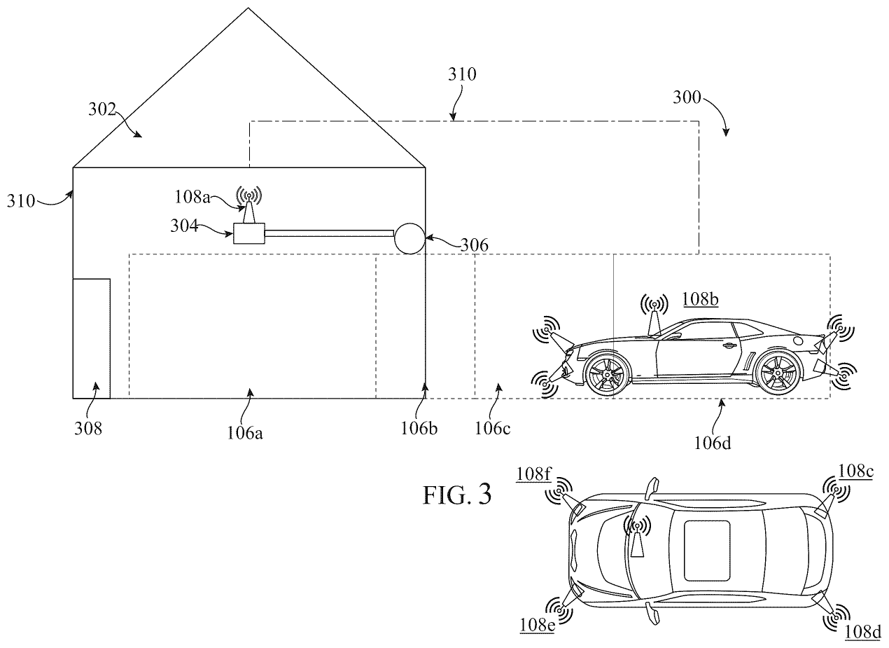

FIG. 3 depicts a side view of the plurality of zones 106a-d in accordance with embodiments of the present disclosure. FIG. 3 depicts an exemplary embodiment of a structure 302 which houses one or more movable barrier operators 304. Vehicular access to structure 302 may be granted by controlling a position of a movable barrier 306 associated with the movable barrier operator 304. As described below, control of the movable barrier operator 304 to open and close the movable barrier 306 can be performed in view of the identified zones 106a-d and the location of a vehicle relative to the zones 106a-d.

In an embodiment, processor 102 may compare the dimensions of the vehicle 210, also referred to as the first dimension, to the calculated usable dimensions of the garage (i.e., the second dimension). This comparison may be used to determine a parking space 212 for the vehicle and/or the boundary of each zone of the plurality of zones 106a-d. This may include a verification that the vehicle can fit within the available space in the garage 310. The system can use geometric calculations to confirm whether the first dimension is smaller than or fits within the second dimension.

Based on the comparison of the first dimension and the second dimension, the processor 102 may identify boundaries between different zones. For example, the processor 102 might distinguish between areas designated for parking and restricted parking areas due to the presence of a movable barrier or other obstruction 206. This may involve mapping out zones based on the available space and vehicle dimensions, ensuring that vehicles can be parked without interference or collision with obstacles and or movable barriers.

The processor 102 may be configured to receive a plurality of information associated with the vehicle based on one or more unique identifiers associated with the vehicle. This may include information such as a vehicle identification number (VIN). The processor 102 can utilize a vehicle's unique identifier to identify information about the vehicle from a database. When the unique identifier is provided, the processor may query the database, which contains comprehensive records on various vehicle attributes. By matching the unique identifier or VIN with the database entry, the processor may retrieve specific details about the vehicle such as the vehicle's make and/or model, height, length, weight, a vehicle rider profile identifying the driver of the vehicle, or the like. Height of the vehicle may refer to the vertical measurement from the ground to the highest point of the vehicle. Length may refer to the overall distance from the front bumper to the rear bumper. The dimensions of the vehicles may be modified according to the presence/absence of tools and equipment that are attached to the vehicle. This may include equipment like luggage racks, bike racks, trailer hitches, trailers, spare tires, and the like. In some cases, information related to the dimensions of the vehicle may be referred to as the first dimension or the first set of dimensions.

With continued reference to FIG. 1, identifying the plurality of zones 106a-d may include identifying a boundary between one or more zones of the plurality of zones 106a-d. Processor 102 may identify the boundary by receiving data associated with the structure. The received data may include measurements, blueprints, images, and the like. The received data may include visual representations of the structure, garage, and/or parking area, potentially capturing details such as walls, obstacles, and vehicle positions. Processor 102 may extract measurements or dimensions of the structure, garage, and/or parking area from the received data. These dimensions may be used to identify the boundaries between two or more zones 106a-d. Image processing techniques, as discussed in greater detail herein below, may be used to extract the dimensions of the structure, garage, and/or parking area from the received data. The received data may be provided to the system via sensors, cameras, and/or manual input.

Processor 102 may identify the plurality of zones 106a-d using an image processing model to analyze image data. The image processing model may be designed to identify boundaries of a zone and other landmarks within the provided image data. The image processing model may process the image data using techniques such as edge detection, thresholding, or morphological operations to identify boundaries and landmarks. The image processing model may highlight the edges within an image by detecting areas of rapid intensity change. These edges may correspond to the boundaries of different zones and/or landmarks.

The image processing model may also employ one or more thresholding techniques to segment the image data based on pixel intensity values. By applying a threshold value, the image data may be divided into regions of interest, which may be used to help isolate the boundaries of the zone(s) from the background. Additionally, the image processing model may employ a number of image processing techniques such as binary thresholding or adaptive thresholding to differentiate between the zone boundaries and other elements in the image data.

Processor 102 may refine the boundary detection, using morphological operations such as dilation and erosion. These operations may help in closing gaps in detected edges or removing small noise artifacts, making the boundaries of the zones and landmarks more distinct and continuous.

For landmark detection, processor 102 may apply one or more template matching techniques. This approach may compare known images and/or templates of landmarks to the current image with the hope of finding a match. Exemplary templates may include images of movable barriers, movable barrier operators, walls, shelves, stairs, parking spaces, parked vehicles, movable barrier tracks, and the like. This method may be specifically useful for identifying specific, known landmarks within the image data.

The image processing model may include a machine learning model. Inputs to the machine-learning model may include information associated with the structure, image data, examples of zones, examples of landmarks, examples of obstacles, and the like. Outputs to the machine-learning model may include an identification of the plurality of zone 106a-d tailored to the information associated with the structure (i.e., image data).

The machine learning model may include one or more Convolutional Neural Networks (CNNs), a type of deep learning model specifically designed for visual data analysis. CNNs may be used to process the image data by applying a series of convolutional layers that automatically learn spatial hierarchies of features such as edges, textures, and shapes. These features may assist in detecting and classifying objects within the image data, including boundaries and landmarks. For boundary detection, models like U-Net and Mask R-CNN may be used, as they specialize in semantic segmentation and can output maps highlighting zone boundaries with precision. Landmark recognition can be achieved through training the CNN model on annotated image data, allowing it to identify and label specific features such as a movable barrier or other landmarks. Examples of such models include U-Net, which segments images into distinct regions, Mask R-CNN, which provides pixel-wise object masks, YOLO (You Only Look Once), which performs real-time object detection and bounding box prediction, and DeepLab, which segments images at multiple scales using atrous convolution.

In some embodiments, the image processing module may be trained using a plurality of training data. Training data may include a plurality of data entries containing a plurality of inputs that are correlated to a plurality of outputs for training a processor by a machine-learning process. In an embodiment, training data may include a plurality of images correlated to examples of zones and/or landmarks. Training data for an image processing model may include a large set of labeled images that represent various categories or scenarios the model needs to recognize. These categories may include things like landmarks, obstacles, zone boundaries, structures, and the like. This training includes not only raw images but also annotations or labels that provide context. These annotations may highlight features like boundaries between the zones or landmarks. Alternatively, the annotations may include one or more labeled obstacles. To ensure the model generalizes well, the training set often includes images from different environments, lighting conditions, and angles, along with variations in resolution and quality.

### Locating the Vehicle Relative to the Plurality of Zones

Continuing to refer to FIG. 1, processor 102 may be instructed to perform operations that comprise obtaining information associated with a location 110 of a vehicle relative to the plurality of zones 106a-d as a function of a spatial relationship 112 between the first wireless communication accessory 108a and the second wireless communication accessories 108b-f. The location 110 of a vehicle may refer to the vehicle spatial position within a defined geographic area that has been segmented into distinct zones or areas. Determining the vehicle's location relative to these zones 106a-d may involve identifying the vehicle's precise coordinates within a geographic space. Additionally, it may also include evaluating the coordinates proximity to the boundaries of each zone 106a-d. This spatial relationship 112 may provide context regarding vehicles interactions within the zones. This may include identifying when a vehicle enters/exits a zone.

Determining the location of a vehicle relative to a plurality of zones 106a-d within a geographic area may involve identifying the spatial relationship 112 between the first wireless communication accessory 108a and the second wireless communication accessories 108b-f. The spatial relationship 112 between two wireless communication accessories 108a-f may refer to their positional arrangement relative to each other in physical space. To gather the initial spatial arrangement of at least one wireless communication accessory, the second wireless communication accessories 108b-f may be used to determine its own precise location using GPS satellites, Bluetooth technology, Wi-Fi technology, and/or UWB technology, establishing a stable reference point inside the vehicle. Based on this initial location, the processor 102 may integrate the dimensions of the vehicle, including its length, width, and height to accurately calculate the position of specific points on the vehicle relative to its center or edges. This may be done using mathematical transformations and coordinate systems to translate GPS, UWB, Wi-Fi, or Bluetooth coordinates into the vehicle's local coordinate framework. As the vehicle moves through the zones 106a-d, the processor may compare the calculated position against predefined boundaries or markers within the zones 106a-d. This comparison may allow the processor 102 to determine the vehicle's entry, exit, or presence within specific zones 106a-d based on the spatial relationship of the vehicle relative to these boundaries or markers.

Based on the initial location of the wireless communication accessory, a UWB system may be used to ascertain the spatial relationship 112 between a first and second wireless communication accessories 108a-f. UWB systems determine the spatial relationship by tracking the location of each of the wireless communication accessories 108a-f using UWB signals. Wireless communication accessories 108a-f that are a part of a UWB system may include an anchor, tag, and/or a transceiver.

The first and second wireless communication accessories 108a-f may be equipped with UWB tags, anchors, and/or transceivers that are capable of emitting and/or receiving short pulses of radio waves across a broad spectrum. When a ranging process is initiated, the second wireless communication accessories 108b-f may emit a signal pulse which may be received by the first wireless communication accessory 108a. The time taken for this signal to travel from the second wireless communication accessories 108b-f to the first wireless communication accessory 108a may be measured to leverage the UWB's ability to measure time intervals in picoseconds. By knowing the precise time each signal pulse is sent and received, the UWB system may calculate the distance between the first wireless communication accessory 108a and the second wireless communication accessories 108b-f. This distance measurement may provide a direct indication of the spatial separation between the first and second wireless communication accessories 108a-f. By iteratively repeating this process over time the processor 102 can track the location of the vehicle in real time.

In an embodiment, a tag may emit UWB signals at regular intervals which may be tracked by UWB anchors. The UWB anchors may process these signals to determine the precise distance between the tag and each anchor. By triangulating these measurements, the system may calculate the exact location of the UWB tag with high accuracy. The UWB anchor may receive signals from UWB tags and relay the received signals to the processor 102 or a networked system. In an embodiment, the tag may serve as the first wireless communication accessory 108a, whereas the second wireless communication accessories 108b-f may serve as anchors. In some cases, there may be a central controller or a mobile app that interfaces with both the UWB tags and anchors. This system may process the location data received from the anchors and provides real-time tracking information to users.

In another embodiment, processor 102 may identify the spatial relationship 112 between the first wireless communication accessory 108a and the second wireless communication accessories 108b-f using a Bluetooth system. In this embodiment, both wireless communication accessories may be equipped with Bluetooth transceivers. These Bluetooth transceivers may be capable of transmitting and receiving radio signals in the 2.4 GHz frequency range. Identifying the spatial relationship 112 using a Bluetooth system may involve recording the signal strength and proximity detection between the first and second wireless communication accessories 108a-f. Proximity for pairing the wireless communication accessories 108a-f may include a range of up to 100 meters depending on the Bluetooth class and version. Once paired, the wireless communication accessories 108a-f may begin to exchange inquiry and response messages to establish a connection. The Bluetooth system may measure the signal strength (RSSI—Received Signal Strength Indication) between the wireless communication accessories 108a-f during this process. As the first wireless communication accessory 108a emits inquiry messages, the second wireless communication accessories 108b-f may respond with its identification and signal strength information. Alternatively, the second wireless communication accessories 108b-f can emit an inquiry message and the first wireless communication accessory 108a can respond with its identification and signal strength information. By analyzing the RSSI values received at either of the wireless communication accessories 108a-f, processor 102 may estimate the distance between the two accessories 108a-f.

In another embodiment, the spatial relationship 112 between the first wireless communication accessory 108a and the second wireless communication accessories 108b-f may be calculated using a Wi-Fi-based system. Similar to the above-mentioned Bluetooth system, this process may involve leveraging the signal strength and location information provided by Wi-Fi access points. In this embodiment both wireless communication accessories 108a-f may be equipped with Wi-Fi transceivers. These wireless communication accessories 108a-f may also be connected to nearby Wi-Fi access points which act as reference points for determining their locations. This system 100 may measure the RSSI from these Wi-Fi access points to estimate the proximity of each accessory to the access points and to each other. The Wi-Fi-based system can then use triangulation or trilateration techniques to estimate the coordinates of the wireless communication accessories 108a-f based on their relative signal strengths from multiple Wi-Fi access points. By analyzing how the signal strength varies with distance, the system infers the distance between each accessory and the access points, and consequently calculates their approximate positions. With the spatial coordinates determined, the system can then assess the relative positions of wireless communication accessories 108a-f, determining how far apart they are and in which direction. Additionally, if the Wi-Fi system supports advanced features like Wi-Fi-based geofencing, it can also identify whether the accessories are within or crossing specific virtual boundaries established by Wi-Fi signal zones.

To refine the spatial relationship, the Bluetooth system and/or Wi-Fi System may employ one or more algorithms that track the changes in RSSI over time and apply statistical methods to improve accuracy. This continuous monitoring may help determine when one of the wireless communication accessories 108a-f is within range for reliable communication or when they move out of proximity. The algorithms used to track changes in RSSI may involve techniques for filtering, averaging, and smoothing to handle the inherent variability and noise in signal measurements. In an embodiment, the algorithm may include a moving average algorithm, which calculates the average of RSSI values over a sliding window of time to reduce fluctuations and provide a more stable estimate of signal strength. In an additional embodiment, the algorithm may employ Kalman filtering techniques which may combine multiple measurements and prediction models to estimate the true RSSI while accounting for noise and irregularities. Additionally, the algorithm may employ exponential smoothing. This may apply to a weighted average where more recent RSSI values have higher significance, allowing the algorithm to adapt quickly to changes in signal strength. These algorithms may help improve the accuracy of estimating the distance between wireless communication devices.

In an additional embodiment, identifying a spatial relationship 112 between the first wireless communication accessory 108a and the second wireless communication accessories 108b-f may be performed using a GPS system. In this embodiment, both wireless communication accessories may be equipped with a GPS receiver capable of determining precise geographic coordinates. Initially, both accessories 108a-f may receive signals from multiple GPS satellites to calculate their coordinates, i.e., exact latitude and longitude. Once each accessory has its coordinates, the GPS system can determine the spatial relationship 112 by comparing the coordinates. Additionally, the plurality of zones 106a-d may be represented by geofenced areas. Geofenced areas may be predefined virtual boundaries set up using GPS coordinates. Processor 102 may compare the coordinates of the first wireless communication accessory 108a and the second wireless communication accessories 108b-f against the boundaries of these geofenced areas. By analyzing the location data, processor 102 can ascertain whether each accessory is inside, outside, or crossing into a geofenced area. This spatial information may help in understanding the relative positions of both of the wireless communication accessories 108a-f within the context of these geofenced areas. For example, the system can determine whether both accessories are within the same area, if they are approaching or leaving specific areas, or the like.

In certain embodiments, three or more wireless communication accessories might be employed to track the vehicle's location. System 100 can incorporate multiple tags, anchors, and/or transceivers to triangulate the positions of the wireless communication accessories 108a-f. The three or more wireless communication accessories may include wireless communication accessories that are associated with any system described herein, including but not limited to UWB systems, Wi-Fi systems, GPS systems, Bluetooth systems, or any combination thereof. This triangulation may enable processor 102 to ascertain the spatial relationships between the wireless communication accessories 108a-f, including their distances, orientations, and precise coordinates within a one or more zones of the plurality of zones 106a-d.

### Pairing the First and Second Wireless Communication Accessories

With continued reference to FIG. 1, the first and second wireless communication accessories 108a-f may be paired based on their location relative to at least one zone of the plurality of zones 106a-d. When two wireless communication accessories enter into within a designated range of the plurality of zones 106a-d, they may initiate a pairing process. In a non-limiting example, upon entering into the fourth zone 106d, the first wireless communication accessory 108a and the second wireless communication accessories 108b-f may pair with one another. The pairing process may include identifying the geolocation of the vehicle and initiating the pairing as a function of the vehicle's proximity to a predefined geographic zone. This may be implemented using either beacon technology or geofencing capabilities. As the vehicle crosses into the fourth zone 106d, processor 102 may be configured to detect the presence of nearby wireless communication accessories 108a-f through signals such as Bluetooth, Wi-Fi, UWB, GPS, and the like. Upon detecting presence of the first wireless communication accessory 108a, processor 102 may automatically initiate pairing.

Pairing two wireless communication accessories 108a-f may refer to the process of establishing a direct and secure connection to enable seamless communication and data exchange. This may begin with each wireless communication accessory 108a-f detecting the presence of the other using wireless technologies such as Bluetooth, Wi-Fi, UWB, and the like. Once detected, one of the first or second wireless communication accessories 108a-f may initiate pairing by sending a request to the other of the first or second wireless communication accessories 108a-f. The request may include identifying information like device name or a unique identifier, e.g., a MAC address. The receiving wireless communication accessories 108a-f may then verify authenticity of the pairing request through authentication mechanisms, which may require entering a PIN code or confirming a pairing prompt displayed on a screen. Alternatively, pairing can occur automatically without user involvement. Upon successful verification, the wireless communication accessories 108a-f may establish a trusted and encrypted connection. This connection may allow the wireless communication accessories 108a-f to exchange information, share data, or control functions based on their capabilities and supported protocols.

### Determining and Communicating a Control Instruction

With continued reference to FIG. 1, processor 102 may be instructed to perform operations that comprise determining a control instruction 114 to control a state 116 of the movable barrier operator 202 in response to the determined location of the vehicle relative to at least one zone of the plurality of zones 106a-d. The control instruction 114 may be a command signal that manages and/or regulates operation of a system or device, such as the movable barrier operator 202. The command signal may specify a desired action or transformation, such as engaging or disengaging a movable barrier operator 202 to affect a state of an associated movable barrier 204. The command signal may also include instructions that affect control of an appliance (e.g., between on and off settings), adjusting settings, initiating a sequence of operations, and the like. When a control signal is received at the movable barrier operator 202, processor(s) of the movable barrier operator 202 may direct a motor or actuator associated with the movable barrier operator 202 to perform the specified action, such as raising or lowering the movable barrier 204. Safety protocols may be embedded in the control signal that halt or pause the movable barrier operator 202 if a blockage of the movable barrier 204 is detected, thereby preventing damage or injury. The control instruction 114 may be issued through various interfaces, including remote controls, mobile apps, or automated systems, and is executed by the movable barrier operator.

To generate a control instruction 114, the processor 102 evaluates the spatial relationship 112 between the first and second wireless communication accessories 108a-f to identify the location of the vehicle. Once the spatial relationship 112 is identified, the processor 102 analyzes this information in relation to the boundaries of the plurality of zones 106a-d. Each zone may have a specific access or security requirements, such as whether the movable barrier operator should open, close, or modify the state of the movable barrier. The processor may then compare the vehicle's location relative to the plurality of zones 106a-d with a set of defined control instructions 114 associated with the zone that the vehicle is moving into or out of. Based on this comparison, the processor 102 may determine the desired control instruction 114. Processor 102 generates a control instruction 114 that specifies how the movable barrier operator 202 should operate the movable barrier 204. The control instruction 114 may include details such as the extent of movement (e.g., fully or partially) and the speed at which the barrier should move, ensuring that the operation aligns with the vehicle's transition and the zone's requirements.

A control instruction 114 may act as an operational command, guiding the movable barrier operator 202 on whether to open, close, or halt the movement of a movable barrier 204. When issued, the control instruction 114 may direct the movable barrier 204 to respond to user inputs or automated systems with the desired action. For instance, if the control instruction 114 is to open the movable barrier 204, the movable barrier operator 202 interprets this instruction to begin lifting or sliding the movable barrier 204, depending on its mechanism. Conversely, a control instruction 114 that includes a close instruction may trigger the movable barrier operator 202 to move the movable barrier 204 towards the closed position. In addition to basic open and close commands, control instructions 114 may specify detailed movements, such as partial openings or closings. For example, a control instruction 114 might direct the movable barrier operator 202 to open the barrier halfway, allowing for partial access while maintaining security or privacy. Similarly, the control instructions 114 might require the movable barrier operator 202 to close the barrier only partially, accommodating specific needs or ensuring safe operation. The movable barrier operator 202 may adjust the movable barrier's movement based on these control instructions 114, the adjustments may include variations in speed and direction. If the instruction calls for a slow, gradual opening or a quick, abrupt stop, the movable barrier operator 202 may adapt accordingly, ensuring the barrier performs precisely as intended.

The control instruction 114 is generated by assessing the vehicle's position in relation to the plurality of zones 106a-d. As the vehicle moves from one zone to another, the processor 102 may determine the corresponding control instruction 114 for the movable barrier operator 202 based on the location of the vehicle. For example, if a vehicle approaches a designated entrance zone, the system might generate a control instruction 114 to open the barrier using movable barrier operator 202. Conversely, when the vehicle transitions to a different zone, such as one indicating the vehicle is leaving or needs restricted access, the system can issue a command to close or partially open the barrier using the movable barrier operator 202.

As a vehicle moves between different zones 106a-d, the system 100 may generate control instructions 114 to guide the actions of the movable barrier operator 202. This control instruction 114 may ensure that the movable barrier operator 202 operates in alignment with the vehicle's current location. For instance, when a vehicle transitions from the fourth zone 106d to the third zone 106c, the system may recognize that the location of the vehicle is approaching an area that may require access to the structure. In response, the control instruction 114 could direct the movable barrier operator 202 to open the barrier. This action may facilitate the vehicle's entry into the structure. Conversely, if the vehicle moves from the second zone 106b to the third zone 106c, the system might determine that the vehicle is exiting the structure. As a result, the control instruction 114 could signal to the movable barrier operator 202 to close the barrier. Similarly, when a vehicle transitions from the second zone 106b to the first zone 106a, the system 100 might issue a control instruction 114 to the movable barrier operator to close the barrier.

In an embodiment, the control instruction 114 may be generated as a function of the vehicle exiting the second zone 106b. Exiting the second zone 106b may refer to the position of the vehicle partially or wholly entering the first zone 106a or third zone 106c from the second zone 106b. Alternatively, exiting the second zone 106b may refer to entering or exiting the structure or garage. The control instruction 114 generated as a function of exiting the second zone 106 may include instructions for the movable barrier operator to open, close, or adjust the position of the movable barrier based on the vehicle's entry/departure into the structure.

With continued reference to FIG. 1, processor 102 may be instructed to perform operations that comprise causing communication of the control instruction 114 to the movable barrier operator 202 to control the state 116 of the movable barrier operator. Controlling the state 116 of a movable barrier operator may involve instructing the movable barrier operator to actuate a movable barrier, such as a garage door or gate, into a desired position. Causing communication of the control instruction 114 may include transmitting a command to the movable barrier operator to adjust the position of the movable barrier, such as opening, closing, pausing, and the like of the movable barrier.

Causing communication of the control instruction 114 may be designed to align the movable barrier operator's movements with the vehicle's transitions between the plurality of zones 106a-d. Upon receiving the control instruction 114, the movable barrier operator 202 may process the command and adjust the movable barrier 204 accordingly. This may involve activating motors or mechanisms associated with the movable barrier operator 202 to physically move the barrier to the desired position. For example, if the control instruction 114 is to open the movable barrier, the movable barrier operator 202 may initiate the appropriate mechanism to lift or slide the movable barrier 204. Conversely, if the instruction is to close or partially close the barrier, the movable barrier operator 202 may be instructed to adjust the movable barrier's movement to securely seal off the entry point.

In addition to being controlled by the system 100 described above, the state 116 of the movable barrier operator may be further affected by command signals received from one or more controllers, such as from one or more wireless communication devices (e.g., smartphones or tablets running movable barrier operator control applications), remote controls, wall switches, or the like. Processor 102 may process the command signals received from the one or more controllers and change the state 116 of the movable barrier by engaging/disengaging the motor or actuator of the movable barrier operator to perform the desired action.

### Determining and Correcting the Orientation of the Vehicle Relative to the Plurality of Zones

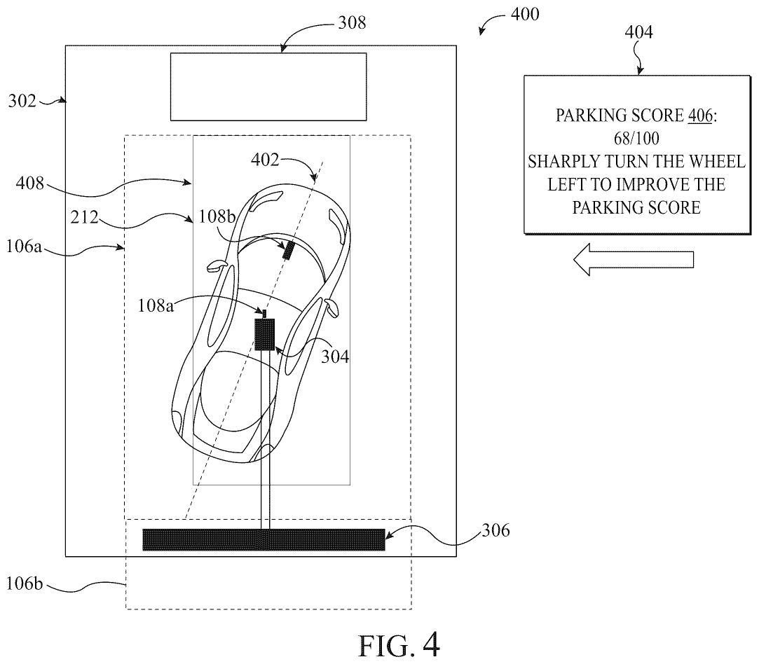

FIG. 4 depicts an exemplary top view of a vehicle disposed at an orientation within at least one zone of the plurality of zones 106a-d. Orientation 402 of the vehicle may refer to the positioning of the vehicle relative to the orientation of first wireless communication accessor 108a. Positioning may include the positioning of the vehicle relative to each zone. Alternatively, the orientation 402 of the vehicle may refer to the angle of the vehicle relative to a fixed location. This fixed location may include but is not limited to the location of the first wireless communication accessory 108a.

The orientation 402 of the vehicle may be quantified using a coordinate system. The wireless communication accessories 108a-f may each include one or more gyroscopes that are configured to measure the orientation 402 of the vehicle. In an embodiment, processor 102 may quantify the orientation 402 of the vehicle as in terms degrees or radians.

The orientation 402 of the vehicle may be compared to the orientation of the first wireless communication accessory 108a. The fixed position of a first wireless communication accessory 108a may include an orientation that is relatively angled with respect to the movable barrier. To compare the vehicle's orientation with that of the first wireless communication accessory 108a, processor 102 may evaluate how the vehicle's orientation compares with the orientation of the first wireless communication accessory 108a. For example, if the vehicle is oriented at 0 degrees and the first wireless communication accessory 108a is oriented parallel to a movable barrier 306 at 90 degrees. This may mean that the vehicle is oriented perpendicular to the movable barrier 306. In the given scenario, the user may be successfully parking the car straight within the parking space. Since the vehicle is oriented at 0 degrees while the first wireless communication accessory 108a is oriented at 90 degrees, this perpendicular alignment may be within a favorable angular range. Alternatively, if the vehicle is oriented 45 degrees while the first wireless communication accessory 108a is oriented at 90 degrees, the vehicle's orientation 402 may be outside of a favorable angular range. This undesirable orientation 402 may denote that the vehicle is not aligned with the fixed wireless communication accessory 108a within an acceptable angular range of 90 degrees. As a result, the vehicle is positioned in a crooked or skewed manner compared to the fixed accessory.

In embodiments, processor 102 may identify an angular range that is considered favorable based on the orientation of the first wireless communication accessory 108a. For example, if the first wireless communication accessory 108a is orientated perpendicular to the movable barrier 306 at 180 degrees. A desirable angular range may be defined as ±30 degrees relative to a perpendicular orientation. Meaning as long as the orientation 402 of the vehicle is within ±30 degrees of 180 degrees and/or 0 degrees, the orientation 402 of the vehicle is considered favorable. The vehicles adherence to a favorable orientation and/or angular range may be quantified by the parking score, as discussed in greater detail herein below.

In some cases, information associated with the dimensions of the vehicle may be used to calculate the orientation of the vehicle. For example, by considering the vehicle's dimensions, such as vehicle length, width, and turning radius, the processor 102 can derive its exact orientation relative to a fixed point or reference point. For instance, a known vehicle length and width may be used to determine the spatial boundaries of the vehicle, e.g., the distance between the front-left bumper and the rear-right bumper, as discussed in greater detail herein above. This data may allow for more precise calculations of the vehicle's orientation.

To calculate orientation 402 of the vehicle, processor 102 may employ a combination of the vehicle's dimensions and orientation data from both fixed and vehicle-mounted wireless accessories, i.e., the first and second wireless communication accessories 108a-f. The orientation of the first wireless communication accessory 108a in a fixed location of the structure 302 may serve as a reference point for comparison with the vehicle-mounted second wireless communication accessories 108b-f. The vehicle-mounted wireless communication accessories 108b-f may generate data on the vehicle's position and orientation as it approaches each zone of the plurality of zones 106a-d. Processor 102 may process the generated data to create a comparison of the orientation of the vehicle-mounted wireless communication accessories 108b-f with that of the fixed wireless communication accessory 108a. By analyzing this relationship, the processor 102 may determine the vehicle's precise orientation relative to the structure. The dimensions of the vehicle may be used to refine the orientation calculation, as they help account for factors such as the vehicle's spatial footprint and turning radius. By integrating the vehicle's size with the comparative orientation data, processor 102 can achieve an accurate representation of the vehicle's orientation 402.

With continued reference to FIG. 4, processor 102 may be instructed to perform operations that comprise processing information associated with the orientation of the vehicle to generate reposition data 404. Reposition data 404 may refer to a set of instructions provided to the driver or another user to guide them in placing the vehicle in an optimal location and orientation within the structure. Reposition data 404 may be generated based on the vehicle's current position, orientation, and its relationship with the surrounding environment, including any fixed references or obstacles. The objective of the reposition data 404 may be to help the driver maneuver the vehicle so that it achieves the most advantageous alignment, whether for parking, aligning with a docking station, or preparing for a specific driving maneuver. In an embodiment, reposition data 404 may be used to position the vehicle in a predetermined location within at least one zone of the plurality of zones 106a-d, such as an assigned parking spot.

In an embodiment, the process of using reposition data 404 may include collecting real-time data about the vehicle's current location and orientation. The collected information may be gathered in any manner disclosed throughout this disclosure. The processor 102 may then analyze the collected information to determine the vehicle's current state, taking into account vehicle position, heading, and spatial alignment.

The processor 102 may compare the vehicle's current location and orientation with the desired target position and orientation, which can be defined by parking lines, docking stations, parking zones, or other reference points. Processor 102 may then employ one or more algorithms to calculate the necessary adjustments to achieve optimal positioning, including steering angles, forward or backward movements, and adjustments to speed. The output of these algorithms may be repositioning data.

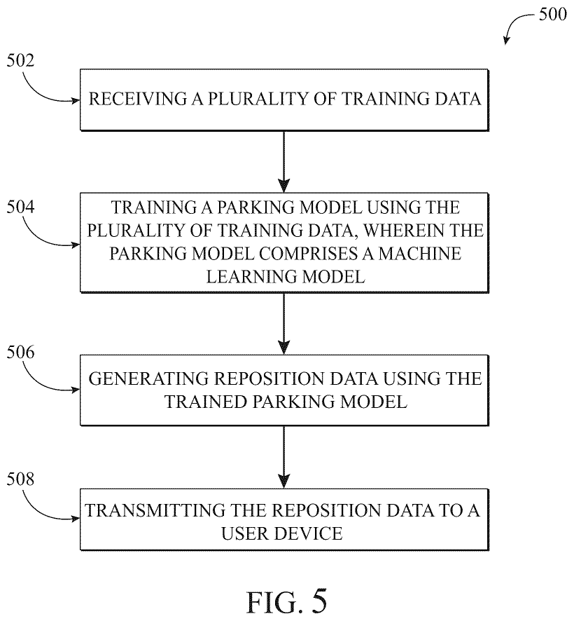

Referring now to FIG. 5, a flow chart diagram of an exemplary method of generating reposition data using a parking model. In some cases, reposition data 404 may be generated using a parking model. A parking model may be a digital simulation of the parking environment and vehicle dynamics. The parking model can be used to guide manual or autonomous parking maneuvers. The parking environment may be mapped in the same or similar process as disclosed herein for identifying the plurality of zones 106a-d. The vehicle's current position, orientation, and dimensions may serve as inputs into the parking model. Using algorithms that simulate the vehicle's movement and interactions with the parking environment, the parking model may calculate the optimal path of the vehicle relative to the parking environment and may provide adjustments that allow for precise parking. For example, the parking model can help generate the reposition data 404 which can include specific instructions on steering angles, acceleration, and braking to align the vehicle correctly within the parking space.

At step 502, the method includes receiving a plurality of training data. Training data for the parking model may include the location of multiple parking zones, combined with historical tracking data from previous parking attempts and historical reposition data. Historical tracking data from previous parking attempts may include records of the vehicle's movements, orientation adjustments, and outcomes during past parking maneuvers. This data may reveal patterns and common challenges faced during parking attempts, providing insight into how varied factors influence successful parking. By integrating this historical data into the parking model, the system learns from past experiences to improve its algorithms. The parking model may analyze the spatial relationships and typical maneuvers needed to navigate various parking zones effectively. The parking model uses this historical information to identify optimal steering angles, speeds, and adjustments required for different types of parking spaces and scenarios. The historical reposition data helps the model understand how previous adjustments impacted parking success, allowing the parking model to refine its predictions and recommendations.

At step 504, the method includes training a parking model using the plurality of training data, wherein the parking model comprises a machine learning model. the parking model may be implemented as a machine learning model that learns from a vast dataset of parking scenarios to enhance accuracy and effectiveness. By training on historical data, including the locations of various parking zones, past parking attempts, and reposition data, the machine learning model may identify patterns and trends in how vehicles successfully navigate and park. The model continuously improves its predictions and recommendations by analyzing these patterns and adapting its algorithms based on new data. This enables the parking model to provide improved guidance for both manual and autonomous parking maneuvers.

Training a parking model may involve refining its parameters, such as weights and biases, by processing historical repositioning data and past parking attempts. The parking model may be used to accurately generate repositioning data 404 based on a set of inputs. During training, an error function may be used to evaluate the difference between the model's predicted repositioning data 404 and the actual repositioning data from past parking attempts. This discrepancy may be used to guide the iterative adjustment of the parking model's parameters, such as weights and biases. The error function may be used to minimize this error by continuously refining the parking model's parameters through processes like gradient descent. As these adjustments proceed, the parking model may become increasingly accurate in predicting repositioning data 404 based on historical data. The adjustments may continue to proceed until performance stabilizes, indicating that the predictions are sufficiently accurate. By using techniques such as gradient descent and back-propagation, the parking model learns to minimize the discrepancy between its predicted outputs and the real repositioning outcomes, ultimately improving its ability to assist with parking decisions. This training process may be applied to any algorithm, machine leaning model, or model described herein.

At step 506, the method may include generating reposition data using the parking model. The parking model generates reposition data 404 to guide the driver in placing the vehicle optimally within a parking structure. The parking model generates reposition data 404 by first assessing the vehicle's current position and orientation relative to its parking space. It then analyzes how these factors interact with surrounding obstacles and fixed references, such as parking lines or obstructions. Using this data, the model calculates the adjustments needed to align the vehicle correctly. This may include instructions for steering angle, forward or backward movement, and speed adjustments to ensure the vehicle is optimally positioned within the designated space. The parking model may use the vehicle's dimensions to understand the spatial requirements for maneuvering. This data may help in determining the appropriate adjustments needed to fit the vehicle within a designated space or align it correctly with reference points. The processor may continuously monitor the vehicle's position and orientation. By comparing this data with the desired target position or orientation, the processor may calculate the necessary adjustments to be made by the vehicle. For example, if the vehicle is not aligned with a desired parking spot, the processor may determine how much to turn the steering wheel, whether to drive forward or backward, and the amount of acceleration or deceleration required to achieve optimal positioning.

At step 508, the method includes transmitting the reposition The reposition data may be transmitted to a GUI on a user device or infotainment system within the vehicle. This interface may provide visual cues and instructions, such as arrows indicating the direction to turn the steering wheel, icons for accelerating or decelerating, and guidance on moving forward or backward. The GUI may also display real-time feedback on the vehicle's alignment relative to target markers or reference points. On an infotainment device, the reposition data may be shown in a user-friendly format, often incorporating a combination of text and graphical elements. For instance, a screen may display directional arrows, distance metrics, and proximity alerts. Additionally, voice prompts might be used to provide step-by-step guidance, enhancing the driver's awareness and ability to follow the instructions accurately.

In some embodiments, processor 102 may utilize the reposition data to autonomously park a vehicle by integrating sensor inputs and real-time calculations into its control systems. The processor may analyze the reposition data based on the vehicle's current size, location, and orientation. Using this data, the processor may instruct the vehicle's autonomous driving system about how to adjust the steering wheel, throttle, and brakes to execute precise maneuvers so that the vehicle can autonomously adjust its position and orientation. Thus, making the necessary corrections to park within the designated parking space.

With continued reference to FIG. 4, processor 102 may perform operations that comprise determining a parking score 406 based on the parked location and/or parking space 212 within the first zone 106a. The parking score 406 may quantify how well a vehicle is oriented and positioned within a parked location 408. The parking score 406 may be derived from a combination of measurements and/or criteria, including, for example, the vehicle's alignment relative to the boundaries of the parking spot, the vehicle's central positioning within the parking spot, and the vehicle's relative orientation. Alignment may include measurements of how well the vehicle aligns with the designated lines, markers, and/or boundaries of the parking space 212. Central positioning may evaluate how evenly the vehicle is positioned within the parked location and/or parking space 212. This may include an evaluation of the clearances from the boundaries on all sides. In an embodiment, the terms parked location and parking space 212 may be used interchangeably throughout this disclosure.

The parking score 406 may aggregate the alignment, central positioning, and orientation information into a single numerical value. The single numerical value can be determined on a scale from 0 to 100, or another range, where a higher score indicates a relatively better parking score 406, i.e., relatively better positioning and orientation. The parking score 406 may be expressed as a numerical score, a linguistic value, bar graph, or an alphabetical score. By way of non-limiting example, the parking score can alternatively be scaled from 0-1, 1-10, 1-1000, or the like, wherein a parking score 406 of 1 may represent a vehicle that is not parked within the bounds of the parking location 408 and a maximum score may represent a vehicle that is perfectly aligned within the parking location 408. In another non-limiting example, linguistic values may include, “Too far right,” “Too far left,” “Obstructing the movable barrier,” “Slightly Misaligned,” “Moderately Misaligned,” “Severely Misaligned,” “Perfect Alignment,” and the like. Linguistic values may correspond to a linguistic variable score range. For example, if a vehicle receives a score between 40-60 on a scale from 1-100, the linguistic value may be considered “Moderately Misaligned.” A parking score 406 may also quantify the location of the vehicle relative to the parking location 408 as positive or negative. This may be done to show how far to the left/right or forward/backward the vehicle is within the parking location 408. For example, if a vehicle was parked to the far left, the parking score 406 may be represented as a negative value, whereas if the vehicle was parked to the far right the parking score may be represented as positive value.

Processor 102 may generate the parking score 406 by analyzing the positioning of the vehicle based on the spatial relationship between the two wireless communication accessories 108a-f. At least one of these wireless communication accessories 108a-f, such as the first wireless communication accessory 108a, may be mounted at a fixed position within the structure, e.g., garage. Each vehicle may be equipped with its own wireless communication accessory, i.e., each vehicle can include one or more discrete second wireless communication accessories 108b-f, that communicates with the fixed wireless communication accessory 108a. The resultant information can be used to determine a precise location and orientation of each vehicle within the garage 310. The processor 102 may score how well each vehicle is positioned relative to the garage's walls, the assigned parking locations 408, obstructions and obstacles, or even other vehicles inside and/or outside the garage. For instance, if the vehicles are parked parallel to the garage walls, centered within their designated spaces, and maintain adequate clearance to avoid obstruction, the processor may generate a favorable parking score for the vehicles based on these factors. For example, if Car A is well-centered and properly aligned, it might receive a high score, such as 85 out of 100. In contrast, if Car B is slightly misaligned or too close to Car A or the garage walls, it might receive a relatively lower score, like 60.

With continued reference to FIG. 4, processor 102 may be instructed to identify the parked location within the first zone 106a. This may be done by comparing the first zone 106a to a first dimension associated with a vehicle. The comparison may involve an assessment of how well the vehicle fits within a designated parking space by analyzing both the spatial characteristics of the first zone 106a and the vehicle's physical dimensions. The processor 102 may compare these dimensions to determine if the vehicle fits within the defined space and maintains adequate clearance on all sides. In some cases, this may be done using the parking model as described herein.

The clearances on each side of the vehicle may be determined as a function of the first dimension. The system may define the parking space 212 based on the size of the first zone 106a, the number of vehicles to be parked within the first zone(s) 106a, the vehicles length and width, along with any specific markers or lines that delineate the space. The processor 102 may calculate the required clearance around the vehicle(s) to ensure the vehicle(s) fit comfortably within the space, adding buffers on all sides to account for variations and slight misalignments. Tolerances can be applied to allow for minor deviations, such as a small margin of error around the vehicle's dimensions and dynamic adjustments based on real-time factors. These buffers and tolerances can be individually set by the user, e.g., using a user device running an application in communication with the system 100. The system 100 can compare the vehicle's dimensions, including the buffers and tolerances, to the parking space's boundaries to verify the vehicle fits within the defined area without overlapping or interfering with adjacent spaces. If the vehicle's position is within the acceptable tolerances, the system 100 confirms proper parking. If not, the system 100 may provide instructions for adjustments to ensure optimal fit and clearance.

### Form and Location of the First and Second Wireless Communication Accessories

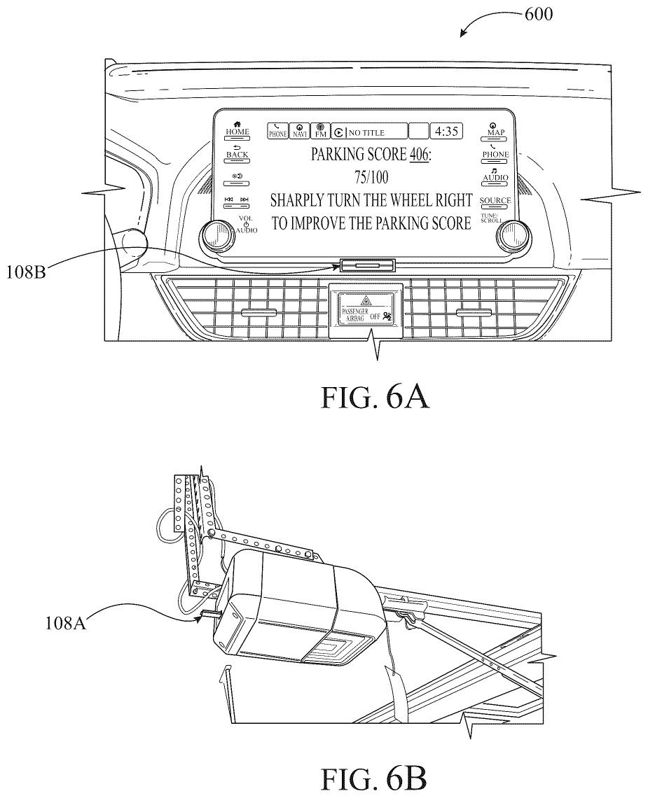

FIGS. 6A-B depict exemplary embodiments of wireless communication accessories in accordance with embodiments of the present disclosure. Wireless communication accessories 108a-f may be designed to track the location of a vehicle or other object (such as a golf cart, motorcycle, or the like) relative to the garage and/or structure.

With continued reference to FIG. 6A, an exemplary depiction of the second wireless communication accessories in the form of a USB plug-in is illustrated. Wireless communication accessories may come in various forms that can be tailored to different use cases. This may include embodiments where the wireless communication accessory is a connectorized dongle configured to plugged into a port of the vehicle (i.e., USB plug-in accessory), surface mounted accessory, vehicle mounted accessory, incorporated into a user device, and the like. The USB plug-in accessory may be designed to be integrated into devices that have USB ports. This may include infotainment systems, navigation systems, electronic control units (ECUs), and the like. USB plug-in accessories may take the form of a compact, rectangular, or cylindrical device that resembles a standard USB flash drive. The USB accessory may serve as a UWB transmitter, receiver, and/or transceiver, depending on its specific role in the system. When inserted the USB accessory may enable real-time communication with other UWB-enabled devices. It may continuously emit UWB signals or process incoming signals to track the location of the vehicle or other objects equipped with UWB tags.

Wireless communication accessories may be mounted in various locations to optimize their functionality and performance. Placements may include within the vehicle wheel wells, bumpers, interior cabin, or the like. In some cases, the accessory may be mounted directly onto the vehicle's frame. Alternatively, the accessory may be incorporated into the infotainment system or computing device within the vehicle. Another option is to incorporate the accessory into the vehicle's antenna system. Additional mounting locations may include under the dashboard, within the engine bay, inside the trunk, underneath the vehicle, inside the headlights, within the glove box, and the like.

In an embodiment, the second wireless communication accessories 108b-f can be mounted to a fixed location within the vehicle. For example, the second wireless communication accessories 108b-f may be coupled to a vehicle chassis, disposed within an engine compartment or interior cabin, coupled to a vehicle bumper, or disposed elsewhere in the vehicle. The relative location of the second wireless communication accessories 108b-f may remain generally constant over successive uses of the vehicle such that the placement of the second wireless communication accessories 108b-f can be referenced to understand the location of outer surfaces/boundaries of the vehicle. Processor 102 may thus use the location of the second wireless communication accessories 108b-f to determine the location of the vehicle (and even the outer boundaries of the vehicle) relative to one or more zones of the plurality of zones 106a-d.

Wireless communication accessories, including USB plug-in accessories, may be calibrated based on their location or the existing device that they are plugged into. This may include being calibrated based on information associated with the vehicle and/or structure that it is attached to. For instance, if the accessory is plugged into a vehicle, it might gather information about the vehicle's dimensions, positioning sensors, and existing GPS data. This may allow the plug-in to integrate with the device's sensors, such as GPS units, accelerometers, and/or gyroscopes to understand the plug-in current location and orientation relative to the vehicle. The goal of the calibration may be to accurately locate the USB plug-in accessory or other wireless communication accessory relative to its surroundings (i.e., a structure or a vehicle.) The calibration process may involve adjusting the accessory's internal algorithms to align with the known characteristics and positioning of the device. For example, if the accessory is mounted on a ceiling, it will calibrate based on the elevated nature of its placement. Additionally, the system may consider environmental factors like obstructions or interference that might affect signal accuracy, making necessary adjustments to maintain precise tracking.

With continued reference to FIG. 6B, an exemplary embodiment of a wireless communication accessory that is integrated into a movable barrier operator. The first wireless communication accessory 108a may be mechanically affixed to a movable barrier operator or another portion of the structure. For example, a wireless communication accessory may be configured to be inserted into a port located on the movable barrier operator. This arrangement may be useful because the spatial orientation of the wireless communication accessory is known. The spatial orientation of the first wireless communication accessory may be used to identify the spatial orientation of the vehicle or the second wireless communication accessories 108b-f. In an embodiment, the first wireless communication accessory may be mounted at any angle relative to the movable barrier. Additionally, a first wireless communication accessory may be mounted to any wall or surface within the structure. This may include ceilings, floors, walls, boundaries, and the like.

The first wireless communication accessory 108a may be designed to accommodate a variety of installation configurations within a structure or garage. The first wireless communication accessory 108a may be affixed to the floor, mounted on a wall or ceiling, attached to a structural member, and/or placed upon a shelf, in accordance with the spatial and functional requirements of the user. In some embodiments, the first wireless communication accessory 108a may be inserted into to a standard electrical power socket to ensure uninterrupted operation. In other embodiments, the first wireless communication accessory 108a may be attached to a movable barrier operator 202 as shown in FIG. 6B. The first wireless communication accessory 108a is also adaptable for attachment to structural beams or any other stable surfaces as may be necessary.

In some cases, the system may provide a notification to the user upon detecting a change in the position of the first wireless communication accessory 108a. If the system 100 detects that the first wireless communication accessory 108a has moved since formation of the boundaries, the system may trigger an alert. Triggering the alert may involve sending a notification from the first wireless communication accessory 108a, or another local or remote component, to a user device, such as vehicle infotainment screen, a smartphone or a tablet, which indicates that the location of the first wireless communication accessory 108a has changed. The notification may include information about a new position of the first wireless communication accessory 108a, a detected time of the movement, instructions for updating the boundaries, and/or any potential impacts of the detected movement on the vehicle's guidance or parking process in response thereto. In some cases, the notification may prompt the user to recalibrate the system based on the new position of the first wireless communication accessory 108a.

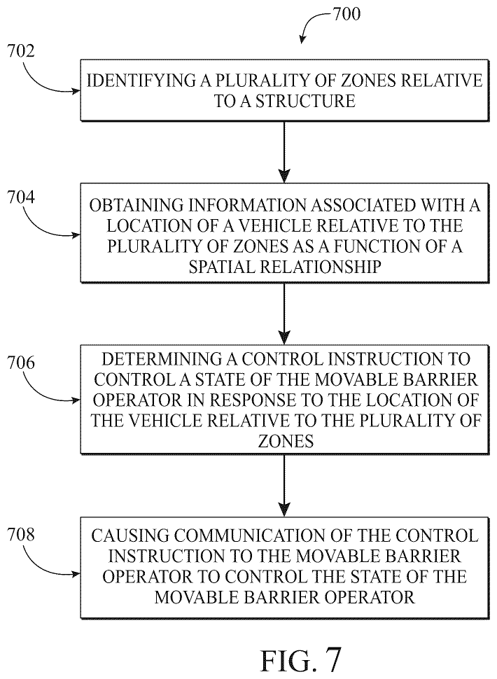

FIG. 7 depicts a flow chart diagram of an exemplary method for controlling a movable barrier operator according to example embodiments of the present disclosure. Although FIG. 7 depicts steps performed in a particular order for purposes of illustration and discussion, the methods of the present disclosure are not limited to the particularly illustrated order or arrangement. The various steps of method 700 can be omitted, rearranged, combined, and/or adapted in various ways without deviating from the scope of the present disclosure.

At step 702, the method includes identifying, by a computing system comprising one or more processors, a plurality of zones relative to a structure, wherein the structure comprises a movable barrier operator communicatively connected to a first wireless communication accessory configured to detect a second wireless communication accessory. In an embodiment, the first wireless communication accessory may include a receiver of an ultra-wide band (UWB) system, while the second wireless communication accessory may include a transmitter of the UWB system.

In some cases, the plurality of zones may comprise a first zone, a second zone, a third zone, and a fourth zone. The first zone may be associated with a secured area enclosed by a movable barrier controlled by the movable barrier operator. Additionally, the third zone may be associated with a non-secured area outside of the movable barrier.

At step 704, the method includes obtaining, by the computing system, information associated with a location of a vehicle relative to the plurality of zones as a function of a spatial relationship between the first wireless communication accessory and the second wireless communication accessory, wherein the second wireless communication accessory is mounted to the vehicle.

In an embodiment, obtaining information associated with the location of the vehicle relative to the plurality of zones may include determining, by the computing system, a first dimension associated with the vehicle based on the received information. Determining the first dimension may include receiving, at the first wireless communication accessory, data from the second wireless communication accessory. Additionally, determining the first dimension may include comparing the received data to a reference data comprising dimensional information associated with a plurality of different vehicles. Determining the first dimension may include determining the first dimension based on the comparison. Obtaining information associated with the location of the vehicle relative to the plurality of zones also includes triangulating an orientation of the vehicle within at least one zone of the plurality of zones as a function of the spatial relationship and the first dimension.

At step 706, the method includes determining, by the computing system, a control instruction to control a state of the movable barrier operator in response to the location of the vehicle relative to at least one zone of the plurality of zone.

In an embodiment, controlling the state of the movable barrier operator may include engaging the movable barrier operator as a function of the vehicle exiting the second zone.

At step 708, the method includes causing, by the computing system, communication of the control instruction to the movable barrier operator to control the state of the movable barrier operator.

In an embodiment, the method may further include processing, by the computing system, information associated with the orientation of the vehicle to generate reposition data associated with the vehicle. Additionally, the method may include transmitting, by the computing system, the reposition data to a user device.

In an embodiment, the method may further include tracking, by the first wireless communication accessory, the vehicle moving between the plurality of zones. The method may additionally include determining, by the computing system, a parked location of the vehicle based on the tracking. The method may also include determining, by the computing system, a parking score based on the parked location, wherein the parking score is associated with parking a first zone of the plurality of zones. The method may include generating, by the computing system, a notification when the parking score is lower than a prescribed threshold.

Further aspects of the invention are provided by one or more of the following embodiments:

Embodiment 1. A computing system for controlling a movable barrier operator, the system comprising: one or more processors; and one or more non-transitory computer-readable media that collectively store instructions that, when executed by the one or more processors, cause the computing system to perform operations, the operations comprising: identifying a plurality of zones relative to a structure, wherein the structure comprises a movable barrier operator communicatively connected to a first wireless communication accessory configured to track a second wireless communication accessory; obtaining information associated with a location of a vehicle relative to the plurality of zones as a function of a spatial relationship between the first wireless communication accessory and the second wireless communication accessory, wherein the second wireless communication accessory is mounted to the vehicle; determining a control instruction to control a state of the movable barrier operator in response to the location of the vehicle relative to at least one zone of the plurality of zones; and causing communication of the control instruction to the movable barrier operator to control the state of the movable barrier operator.

Embodiment 2. The system of embodiment 1, wherein obtaining the information associated with the location of the vehicle relative to the plurality of zones comprises: receiving a first dimension associated with the vehicle; and triangulating an orientation of the vehicle within at least one zone of the plurality of zones as a function of the spatial relationship and the first dimension.

Embodiment 3. The system of embodiment 2, wherein the operations further comprise: processing information associated with the orientation of the vehicle to generate reposition data associated with the vehicle; and transmitting the reposition data to a user device.

Embodiment 4. The system of embodiment 1, wherein the operations further comprise wirelessly pairing the first wireless communication accessory and the second wireless communication accessory as a function of the location of the vehicle being inside at least one zone of the plurality of zones.

Embodiment 5. The system of embodiment 1, wherein the first wireless communication accessory comprises a receiver of an ultra-wide band (UWB) system; and the second wireless communication accessory comprises a transmitter of the UWB system.

Embodiment 6. The system of embodiment 1, wherein the plurality of zones comprises a first zone, a second zone, a third zone, and a fourth zone, wherein the second zone is associated with a location of a movable barrier controlled by the movable barrier operator.

Embodiment 7. The system of embodiment 6, wherein controlling the state of the movable barrier operator comprises engaging the movable barrier operator as a function of the vehicle exiting the second zone.

Embodiment 8. A method for controlling a movable barrier operator, the method comprising: identifying, by a computing system comprising one or more processors, a plurality of zones relative to a structure, wherein the structure comprises a movable barrier operator communicatively connected to a first wireless communication accessory configured to detect a second wireless communication accessory; obtaining, by the computing system, information associated with a location of a vehicle relative to the plurality of zones as a function of a spatial relationship between the first wireless communication accessory and the second wireless communication accessory, wherein the second wireless communication accessory is mounted to the vehicle; determining, by the computing system, a control instruction to control a state of the movable barrier operator in response to the location of the vehicle relative to at least one zone of the plurality of zones; and causing, by the computing system, communication of the control instruction to the movable barrier operator to control the state of the movable barrier operator.

Embodiment 9. The method of embodiment 8, wherein obtaining information associated with the location of the vehicle relative to the plurality of zones comprises: determining, by the computing system, a first dimension associated with the vehicle based on the received information, wherein determining the first dimension comprises: receiving, at the first wireless communication accessory, data from the second wireless communication accessory; comparing the received data to a reference data comprising dimensional information associated with a plurality of different vehicles; and determining the first dimension based on the comparing; and triangulating an orientation of the vehicle within at least one zone of the plurality of zones as a function of the spatial relationship and the first dimension.

Embodiment 10. The method of embodiment 9, wherein the method further comprises: processing, by the computing system, information associated with the orientation of the vehicle to generate reposition data associated with the vehicle; and transmitting, by the computing system, the reposition data to a user device.

Embodiment 11. The method of embodiment 8, further comprising: tracking, by the first wireless communication accessory, the vehicle moving between the plurality of zones; determining, by the computing system, a parked location of the vehicle based on the tracking; determining, by the computing system, a parking score based on the parked location, wherein the parking score is associated with a parking accuracy within a first zone of the plurality of zones; and generating, by the computing system, a notification when the parking score is lower than a prescribed threshold.

Embodiment 12. The method of embodiment 8, wherein the first wireless communication accessory comprises a receiver of an ultra-wide band (UWB) system; and the second wireless communication accessory comprises a transmitter of the UWB system.

Embodiment 13. The method of embodiment 8, wherein the plurality of zones comprises a first zone, a second zone, a third zone, and a fourth zone, wherein: the first zone is associated with a secured area enclosed by a movable barrier controlled by the movable barrier operator, and the third zone is associated with a non-secured area outside of the movable barrier.

Embodiment 14. The method of embodiment 13, wherein controlling the state of the movable barrier operator comprises engaging the movable barrier operator as a function of the vehicle exiting the second zone.

Embodiment 15. A computing system for controlling a movable barrier operator, the system comprising: one or more processors; and one or more non-transitory computer-readable media that collectively store instructions that, when executed by the one or more processors, cause the computing system to perform operations, the operations comprising: identifying a plurality of zones relative to a garage, wherein the garage comprises a movable barrier operator communicatively connected an ultra-wide band (UWB) system, wherein the UWB system comprises an anchor and a tag; obtaining information associated with a location of a vehicle relative to the plurality of zones as a function of a spatial relationship between the anchor and the tag, wherein the anchor is mounted to the vehicle; determining, by the computing system, a control instruction to control a state of the movable barrier operator in response to the location of the vehicle relative to at least one zone of the plurality of zones; and causing communication of the control instruction to the movable barrier operator to control the movable barrier operator.

Embodiment 16. The system of embodiment 15, wherein obtaining the information associated with the location of the vehicle relative to the plurality of zones comprises: receiving a first dimension associated with the vehicle; and determining an orientation of the vehicle within at least one zone of the plurality of zones as a function of the spatial relationship and the first dimension.

Embodiment 17. The system of embodiment 16, wherein the operations further comprise: processing information associated with the orientation of the vehicle to generate reposition data associated with the vehicle; and transmitting the reposition data to a user device.

Embodiment 18. The system of embodiment 16, wherein identifying the plurality of zones comprises identifying a boundary between a first zone and a second zone of the plurality of zones, the first zone associated with at least a portion of a secured area of the garage and the second zone disposed between the first zone and an exterior of the garage, wherein identifying the boundary comprises: receiving data associated with the garage; processing the data to identify a second dimension associated with the garage; comparing the first dimension and the second dimension; and identifying the boundary as a function of the comparison.

Embodiment 19. The system of embodiment 18, wherein identifying the plurality of zones further comprises: processing the data to identify an obstruction within the garage, wherein the data includes image data; and adjusting the second dimension as a function of the obstruction.

Embodiment 20. The system of embodiment 15, wherein the plurality of zones comprises: a first zone located entirely within the garage; a second zone located at a location associated with a movable barrier controlled by the movable barrier operator; a third zone located entirely outside of the garage; and a fourth zone located aft of the third zone.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A computing system for controlling a movable barrier operator, the system comprising:
one or more processors; and
one or more non-transitory computer-readable media that collectively store instructions that, when executed by the one or more processors, cause the computing system to perform operations, the operations comprising:
identifying a plurality of zones relative to a structure, wherein the structure comprises a movable barrier operator communicatively connected to a first wireless communication accessory configured to track a second wireless communication accessory;
obtaining information associated with a location of a vehicle relative to the plurality of zones as a function of a spatial relationship between the first wireless communication accessory and the second wireless communication accessory, wherein the second wireless communication accessory is mounted to the vehicle;
determining a control instruction to control a state of the movable barrier operator in response to the location of the vehicle relative to at least one zone of the plurality of zones; and
causing communication of the control instruction to the movable barrier operator to control the state of the movable barrier operator.

2. The system of claim 1, wherein obtaining the information associated with the location of the vehicle relative to the plurality of zones comprises:
receiving a first dimension associated with the vehicle; and
triangulating an orientation of the vehicle within at least one zone of the plurality of zones as a function of the spatial relationship and the first dimension.

3. The system of claim 2, wherein the operations further comprise:
processing information associated with the orientation of the vehicle to generate reposition data associated with the vehicle; and
transmitting the reposition data to a user device.

4. The system of claim 1, wherein the operations further comprise wirelessly pairing the first wireless communication accessory and the second wireless communication accessory as a function of the location of the vehicle being inside at least one zone of the plurality of zones.

5. The system of claim 1, wherein:
the first wireless communication accessory comprises a receiver of an ultra-wide band (UWB) system; and
the second wireless communication accessory comprises a transmitter of the UWB system.

6. The system of claim 1, wherein the plurality of zones comprises:
a first zone, a second zone, a third zone, and a fourth zone,
wherein the second zone is associated with a location of a movable barrier controlled by the movable barrier operator.

7. The system of claim 6, wherein controlling the state of the movable barrier operator comprises engaging the movable barrier operator as a function of the vehicle exiting the second zone.

8. A method for controlling a movable barrier operator, the method comprising:
identifying, by a computing system comprising one or more processors, a plurality of zones relative to a structure, wherein the structure comprises a movable barrier operator communicatively connected to a first wireless communication accessory configured to detect a second wireless communication accessory;
obtaining, by the computing system, information associated with a location of a vehicle relative to the plurality of zones as a function of a spatial relationship between the first wireless communication accessory and the second wireless communication accessory, wherein the second wireless communication accessory is mounted to the vehicle;
determining, by the computing system, a control instruction to control a state of the movable barrier operator in response to the location of the vehicle relative to at least one zone of the plurality of zones; and
causing, by the computing system, communication of the control instruction to the movable barrier operator to control the state of the movable barrier operator.

9. The method of claim 8, wherein obtaining information associated with the location of the vehicle relative to the plurality of zones comprises:
determining, by the computing system, a first dimension associated with the vehicle based on the received information, wherein determining the first dimension comprises:
receiving, at the first wireless communication accessory, data from the second wireless communication accessory;
comparing the received data to a reference data comprising dimensional information associated with a plurality of different vehicles; and
determining the first dimension based on the comparing; and
triangulating an orientation of the vehicle within at least one zone of the plurality of zones as a function of the spatial relationship and the first dimension.

10. The method of claim 9, wherein the method further comprises:
processing, by the computing system, information associated with the orientation of the vehicle to generate reposition data associated with the vehicle; and
transmitting, by the computing system, the reposition data to a user device.

11. The method of claim 8, further comprising:
tracking, by the first wireless communication accessory, the vehicle moving between the plurality of zones;
determining, by the computing system, a parked location of the vehicle based on the tracking;
determining, by the computing system, a parking score based on the parked location, wherein the parking score is associated with a parking accuracy within a first zone of the plurality of zones; and
generating, by the computing system, a notification when the parking score is lower than a prescribed threshold.

12. The method of claim 8, wherein:
the first wireless communication accessory comprises a receiver of an ultra-wide band (UWB) system; and
the second wireless communication accessory comprises a transmitter of the UWB system.

13. The method of claim 8, wherein the plurality of zones comprises a first zone, a second zone, a third zone, and a fourth zone, wherein:
the first zone is associated with a secured area enclosed by a movable barrier controlled by the movable barrier operator, and
the third zone is associated with a non-secured area outside of the movable barrier.

14. The method of claim 13, wherein controlling the state of the movable barrier operator comprises engaging the movable barrier operator as a function of the vehicle exiting the second zone.

15. A computing system for controlling a movable barrier operator, the system comprising:
one or more processors; and
one or more non-transitory computer-readable media that collectively store instructions that, when executed by the one or more processors, cause the computing system to perform operations, the operations comprising:
identifying a plurality of zones relative to a garage, wherein the garage comprises a movable barrier operator communicatively connected an ultra-wide band (UWB) system, wherein the UWB system comprises an anchor and a tag;
obtaining information associated with a location of a vehicle relative to the plurality of zones as a function of a spatial relationship between the anchor and the tag, wherein the anchor is mounted to the vehicle;
determining, by the computing system, a control instruction to control a state of the movable barrier operator in response to the location of the vehicle relative to at least one zone of the plurality of zones; and
causing communication of the control instruction to the movable barrier operator to control the movable barrier operator.

16. The system of claim 15, wherein obtaining the information associated with the location of the vehicle relative to the plurality of zones comprises:
receiving a first dimension associated with the vehicle; and
determining an orientation of the vehicle within at least one zone of the plurality of zones as a function of the spatial relationship and the first dimension.

17. The system of claim 16, wherein the operations further comprise:
processing information associated with the orientation of the vehicle to generate reposition data associated with the vehicle; and
transmitting the reposition data to a user device.

18. The system of claim 16, wherein identifying the plurality of zones comprises identifying a boundary between a first zone and a second zone of the plurality of zones, the first zone associated with at least a portion of a secured area of the garage and the second zone disposed between the first zone and an exterior of the garage, wherein identifying the boundary comprises:
receiving data associated with the garage;
processing the data to identify a second dimension associated with the garage;
comparing the first dimension and the second dimension; and
identifying the boundary as a function of the comparison.

19. The system of claim 18, wherein identifying the plurality of zones further comprises:
processing the data to identify an obstruction within the garage, wherein the data includes image data; and
adjusting the second dimension as a function of the obstruction.

20. The system of claim 15, wherein the plurality of zones comprises:
a first zone located entirely within the garage;
a second zone located at a location associated with a movable barrier controlled by the movable barrier operator;
a third zone located entirely outside of the garage; and
a fourth zone located aft of the third zone.
